(19) United States
(12) Patent Application Publication
(10) Pub. No.: US 2026/0038072 A1
(43) Pub. Date: Feb. 5, 2026

(54) SYSTEM AND METHOD FOR CONTROLLING SEPARATE MOBILITY MODULES

(71) Applicants: HYUNDAI MOTOR COMPANY, Seoul (KR); KIA CORPORATION, Seoul (KR)

(72) Inventors: HunKee Kim, Hwaseong-si (KR); Min Young Lee, Hwaseong-si (KR)

(73) Assignees: HYUNDAI MOTOR COMPANY, Seoul (KR); KIA CORPORATION, Seoul (KR)

(21) Appl. No.: 18/960,803

(22) Filed: Nov. 26, 2024

(30) Foreign Application Priority Data
Aug. 1, 2024 (KR) 10-2024-0102459

(51) Int. Cl. G06Q 50/47; G01C 21/34; G07B 13/10

(52) U.S. Cl. CPC G06Q 50/47; G01C 21/3469; G07B 13/10

(57) ABSTRACT

A system for controlling a separate mobility module includes the separate mobility module including a space module and a plurality of drive modules for generating power and being coupled with the space module to move the space module to a destination. The system includes a server configured to search for an available drive module among the plurality of drive modules by using call information included in a call command for calling the drive module received from a user terminal of a user; generate information about the available drive module into a drive module list; transmit the generated drive module list to the user terminal; receive drive module selection information about any one of the plurality of drive modules included in the drive module list from the user terminal; and transmit a call signal including the call information to a selected drive module corresponding to the drive module selection information.

### CROSS-REFERENCE TO RELATED APPLICATION

This application claims priority to and the benefit of Korean Patent Application No. 10-2024-0102459 filed in the Korean Intellectual Property Office on Aug. 1, 2024, the entire contents of which are incorporated herein by reference.

### TECHNICAL FIELD

The present disclosure relates to a system and a method for controlling separate mobility modules.

### BACKGROUND

In today's “vehicle”, a drive unit and a cabin where people ride are formed in one form. Therefore, in order to use a vehicle as a means of transportation, users have to purchase an expensive product in which the drive unit and the cabin part are added.

In addition, when a vehicle is not used as a means of transportation, the vehicle cannot be used for any other purpose and remains stationary in the parking lot. In other words, when a vehicle is not used as a means of transportation, the vehicle only occupies a parking space. In reality, the average operation time of the car is driven for only 5% of its lifecycle, so the large number of parking spaces and the high cost to users is a social loss.

To solve this problem, a separate mobility module is being devised, which includes a space module configured to provide the space required by the user and a drive module configured to move the space module. The subject matter described in this background section is intended to promote an understanding of the background of the disclosure and thus may include subject matter that is not already known to those of ordinary skill in the art.

### SUMMARY

The present disclosure aims to provide a system and a method for controlling separate mobility modules when an owner of a space module and an owner of a drive module are different.

An embodiment of the present disclosure provides a system for controlling a separate mobility module. The system includes the separate mobility module including a space module; and a plurality of drive modules configured to generate power to move and configured to be coupled with the space module to move the space module to a destination. The system further includes a server. The server is configured to search for an available drive module among the plurality of drive modules by using call information included in a call command for calling the drive module received from a user terminal of a user. The server is further configured to generate information about the available drive module into a drive module list. The server is further configured to transmit the generated drive module list to the user terminal. The server is further configured to receive drive module selection information about any one of the plurality of drive modules included in the drive module list from the user terminal. The server is further configured to transmit a call signal including the call information to a selected drive module corresponding to the drive module selection information.

The space module may provide a user with a space usable with a specific purpose.

The call information includes a call place. The call place may include location information calculated through a GPS installed on the user terminal or a GPS installed on the space module.

The server may search for a short-distance station closest to a call place among a plurality of stations where a plurality of drive modules is located based on a time of use and the call place included in the call information. The server may search for a drive module completely charged within the short-distance station as the available drive module.

When there is no fully charged drive module within the short-distance station, the server may search for a station closer to the call place after the short-distance station among the plurality of stations and may search for a fully charged drive module within the corresponding station.

The server may calculate first energy required for the available drive module to move to a call place and second energy required for the available drive module to move from the call place to a destination in a state where the available drive module is coupled with the space module based on a weight of the space module, a weight of the available drive module, a total weight of occupants in the space module, a movement distance to the call place, and a movement distance from the call place to the destination. The server may compare the first energy and the second energy to a sum of a battery capacity of the space module and a battery capacity of the available drive module to search for the available drive module.

The drive module list may include a use fee for the available drive module calculated based on an amount of time the plurality of drive modules to be used.

The server may receive real-time movement information from the selected drive module while the selected drive module is coupled with the space module and moves. The server may calculate an estimated arrival time of the selected drive module and the space module. The server may determine whether an additional fee is incurred by using the real-time movement information. The server may transmit the estimated arrival time and information about whether the additional fee is incurred to the user terminal.

The server may search for a station having a shortest distance from a location of the selected drive module among a plurality of stations where the plurality of drive modules is located by using return information included in a return command of the selected drive module received from the user terminal. The server may transmit a return signal including location information of the station having the shortest distance to the selected drive module.

The server may search for at least one first station in the plurality of stations to which the selected drive module is capable of moving with a remaining battery capacity from the location of the selected drive module. The server may search for a second station that has remaining space for parking the selected drive module in the at least one first station.

The server may receive failure situation information from the user terminal or the selected drive module indicating a failure of the selected drive module. The server may search for a station closest to a location where the failure occurred among a plurality of stations where the plurality of drive modules is located by using the failure situation information. The server may determine whether a replaceable drive module exists that is capable of replacing the selected drive module within the closest station. The server may transmit, to the replaceable drive module, a call signal that controls the replaceable drive module to move to the location where the failure occurred.

The server may determine, based on the failure situation information, whether the selected drive module having the failure is currently in an operable state. The server may, when the selected drive module having the failure is in the operable state, transmit a call signal to the replaceable drive module and transmit a return signal to the selected drive module having the failure. The server may, when the selected drive module having the failure is in an inoperable state, transmit, to a car carrier, a call signal that controls the car carrier to load the replaceable drive module and to move to the location where the failure occurred, and transmit, to the car carrier, a return signal that controls the car carrier to move to the location where the failure occurred, to load the selected drive module having the failure, and to return to the closest station.

Another embodiment of the present disclosure provides a method for controlling a separate mobility module. The method includes searching, by a server, for an available drive module among a plurality of drive modules by using call information included in a call command for calling a drive module received from a user terminal of a user. The method further includes generating, by the server, information about the available drive module into a drive module list. The method further includes transmitting, by the sever, the generated drive module list to the user terminal. The method further includes receiving, by the sever, drive module selection information about any one of the plurality of drive modules included in the drive module list from the user terminal. The method further includes transmitting, by the sever, a call signal including the call information to a selected drive module corresponding to the drive module selection information.

Searching for the available drive module may include searching, by the server, for a short-distance station closest to a call place among a plurality of stations where a plurality of power modules is located based on a time of use and the call place included in the call information. Searching for the available drive module may further include searching, by the server, for a drive module completely charged within the short-distance station as the available drive module.

Searching for the available drive module may include, when there is no fully charged drive module within the short-distance station, searching, by the server, for a station closer to the call place after the short-distance station among the plurality of stations, and searching, by the server, for a fully charged drive module within the corresponding station.

The drive module list may include a use fee for the available drive module calculated based on an amount of time the plurality of drive modules to be used.

Transmitting the call signal may include receiving, by the server, real-time movement information from the selected drive module while the selected drive module is coupled with a space module and moves. Transmitting the call signal may further include calculating, by the server, an estimated arrival time of the selected drive module and the space module. Transmitting the call signal may further include determining, by the server, whether an additional fee is incurred by using the real-time movement information. Transmitting the call signal may further include transmitting, by the server, the estimated arrival time and information about whether the additional fee is incurred to the user terminal.

The method may further include searching, by the server, for a station having a shortest distance from a location of the selected drive module among a plurality of stations where the plurality of drive modules is located by using return information included in a return command of the selected drive module received from the user terminal. The method may further include transmitting, by the server, a return signal including location information of the station having the shortest distance to the selected drive module.

Searching for the station having the shortest distance may include searching, by the server, for at least one first station in the plurality of stations to which the selected drive module is capable of moving with a remaining battery capacity from the location of the selected drive module. Searching for the station having the shortest distance may further include searching, by the server, for a second station that has remaining space for parking the selected drive module in the at least one first station.

The method may further include receiving, by the server, failure situation information from the user terminal or the selected drive module indicating a failure of the selected drive module. The method may further include searching, by the server, for a station closest to a location where the failure occurred among a plurality of stations where the plurality of drive modules is located by using the failure situation information. The method may further include determining, by the server, whether a replaceable drive module exists that is capable of replacing the selected drive module within the closest station. The method may further include transmitting, by the server to the replaceable drive module, a call signal that controls the replaceable drive module to move to the location where the failure occurred.

Transmitting the call signal may include determining, by the server based on the failure situation information, whether the selected drive module having the failure is currently in an operable state. Transmitting the call signal may further include, when the selected drive module having the failure is in the operable state, transmitting, by the server, a call signal to the replaceable drive module and transmitting, by the server, a return signal to the selected drive module having the failure. Transmitting the call signal may further include, when the selected drive module having the failure is in an inoperable state, transmitting, by the server to a car carrier, a call signal that controls the car carrier to load the replaceable drive module and to move to the location where the failure occurred, and transmitting, by the server to the car carrier, a return signal that controls the car carrier to move to the location where the failure occurred, to load the selected drive module having the failure, and to return to the closest station.

According to the embodiment of the present disclosure, it is possible to provide a separate mobility service in which a drive module that may be driven autonomously alone and a space module that may be occupied by humans are separated from each other.

The effects of the present disclosure are not limited to those mentioned above, and other effects not mentioned should be apparent to those having ordinary skill in the art from the following description.

### BRIEF DESCRIPTION OF THE DRAWINGS

FIG. 1 is a diagram illustrating a system for controlling a separate mobility module according to an embodiment of the present disclosure.

FIG. 2 is a diagram illustrating an example of a screen provided to a user through a user terminal according to an embodiment of the present disclosure.

FIG. 3 is a diagram for illustrating a space module according to an embodiment of the present disclosure.

FIG. 4 is a diagram for illustrating a drive module according to an embodiment of the present disclosure.

FIG. 5 is a diagram for illustrating a server according to an embodiment of the present disclosure.

FIGS. 6 and 7 are diagrams for illustrating the server according to an embodiment of the present disclosure.

FIG. 8 is a flow diagram for illustrating a process of calling the drive module by a user terminal.

FIG. 9 is a flow diagram for illustrating the process of calling a replaceable module from a user terminal in the event of a failure of the drive module while the drive module is coupled to the space module.

FIG. 10 is a flowchart of a method for controlling a separate mobility module according to an embodiment of the present disclosure.

### DETAILED DESCRIPTION

In describing the embodiments disclosed in the present disclosure, when it is determined that detailed description relating to well-known functions or configurations may make the subject matter of the embodiments disclosed in the present disclosure unnecessarily ambiguous, the detailed description has been omitted. Further, the accompanying drawings are provided for helping to easily understand embodiments disclosed in the present disclosure, and the technical spirit disclosed in the present disclosure is not limited by the accompanying drawings. It should be appreciated that the present disclosure includes all of the modifications, equivalent matters, and substitutes included in the spirit and the technical scope of the present disclosure.

Terms including an ordinary number, such as first and second, are used for describing various components, but the components are not limited by the terms. The terms are used only to discriminate one component from another component.

It should be understood that when one constituent element referred to as being “coupled to” or “connected to” another constituent element, one constituent element may be directly coupled to or connected to the other constituent element, or intervening elements may also be present. In contrast, when one constituent element is “directly coupled to” or “directly connected to” another constituent element, it should be understood that there are no intervening elements present.

In the present disclosure, it should be appreciated that terms “including” and “having” are intended to designate the existence of characteristics, numbers, operations, operations, components, and components described in the present disclosure or a combination thereof. However, the terms do not exclude a possibility of the existence or addition of one or more other characteristics, numbers, operations, operations, components, and components, or a combination thereof in advance. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Hereinafter, the present disclosure is described in detail with reference to the accompanying drawings.

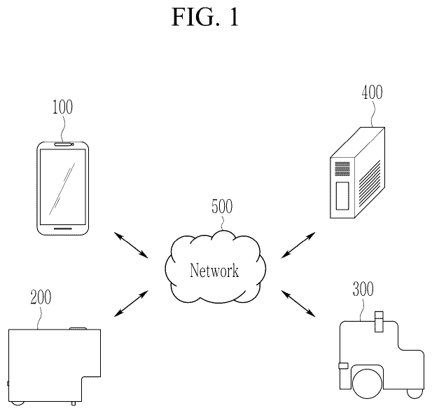

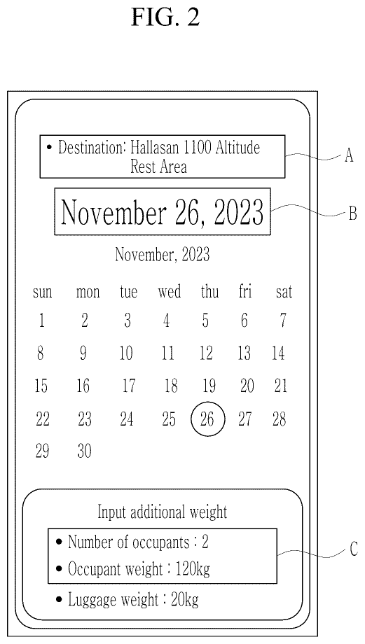

FIG. 1 is a diagram illustrating a system for controlling a separate mobility module according to an embodiment of the present disclosure, and FIG. 2 is a diagram illustrating an example of a screen provided to a user through a user terminal 100 according to an embodiment of the present disclosure.

Referring to FIG. 1, a system for controlling a separate mobility module according to an embodiment of the present disclosure may include a user terminal 100, a space module 200, a drive module 300, and a server 400. The server 400 may be in communication with the user terminal 100, the space module 200, the drive module 300, and the server 400 over a network 500. The separate mobility module may include the space module 200 and the drive module 300.

The user terminal 100 is a communication device that is capable of providing information about the separate mobility module to a user and receiving commands from the user to control configurations included in the separate mobility module. For example, the user terminal 100 may be a communicable computer, a tablet PC, a wireless phone, a mobile phone, a smart phone, a smart watch, a smart glass, a portable gaming device, or the like. In accordance with the embodiment, the user terminal 100 may be implemented as a system embedded in the space module 200. For example, the user terminal 100 may be a PC or the like installed inside the space module 200.

The user terminal 100 may receive user information and information about the space module 200 (hereinafter referred to as “space module information”) from the user. In this case, the user information may be information about the owner of the space module 200. The space module information may include the size, type, weight, battery capacity, and the like of the space module 200. The user terminal 100 may transmit the user information and the space module information to the server 400.

The user terminal 100 may receive a command (hereinafter referred to as a “call command”) from a user to call the drive module 300 to a specific place (hereinafter referred to as a “call place”). The user terminal 100 may transmit the call information included in the call command to the server 400. Here, the call information may include a call place, a date of use, a time of use, a destination, occupant information, additional weight, and the like. The call place may be location information calculated from a GPS installed on the user terminal 100 or a GPS installed on the space module 200. Otherwise, the call place may be a specific place input from the user. The destination refers to a specific place to which the user wishes to move the space module 200 by coupling the drive module 300 to the space module 200. The occupant information may include the number of people who wish to ride in the space module 200, the total weight of the occupants, and the like.

For example, the user terminal 100 may receive a call command including the call information from the user, as illustrated in FIG. 2. FIG. 2 illustrates that the call information, such as a destination A, a date of use B, and occupant information C, may be input through the user terminal 100, but the call information that may be inputted through the user terminal 100 is not limited thereto. In accordance with the embodiment, a user may input a variety of call information into the user terminal 100. As another example, the user may call the drive module 300 through the user terminal 100 to a first specific place and then may command the drive module 300 to move to a second specific place. In this case, the first specific place may correspond to a call place and the second specific place may correspond to a destination.

The user terminal 100 may receive a drive module list from the server 400. The user terminal 100 may provide the drive module list to the user through a display unit. Here, the drive module list is generated by the server 400 and means the result of searching the drive modules 300 that is capable of moving the space module 200 to a destination. The drive module list lists the drive modules 300 that are available to move the space module 200 to the destination.

The user terminal 100 may receive drive module selection information from the user that specifies any one drive module 300 among the plurality of drive modules 300 included in the drive module list. The user terminal 100 may transmit the drive module selection information to the server 400. For example, a user may select one of the plurality of drive modules 300 included in the drive module list provided through the user terminal 100. Information about the selected drive module 300 selected by the user may be transmitted to the server 400 through the user terminal 100 as drive module selection information.

The user terminal 100 may receive input of a command (hereinafter referred to as a “return command”) from the user to return the selected drive module 300 to a station. The user terminal 100 may transmit the return information included in the return command to the server 400. Herein, the return information may include the current location of the selected drive module 300 and the like. The current location of the selected drive module 300 may be location information calculated from the GPS installed in the user terminal 100 or the GPS installed in the selected drive module 300. Otherwise, the current location of the selected drive module 300 may be a specific place input from the user.

The user terminal 100 may transmit failure situation information to the server 400 when the failure situation information indicating a failure of the selected drive module 300 is input from the user. For example, the user may input the information about the failure situation to the user terminal 100 when the drive module 300 fails, and the user may transmit the information about the failure situation to the server 400. Here, the failure situation information may include the type of failure that occurred in the selected drive module 300, whether the selected drive module 300 is operable, and the location where the failure occurred.

The user terminal 100 may receive input of information from the user that the battery capacity is low (hereinafter referred to as “low battery capacity information”). For example, when the user determines that the battery capacity of the drive module 300 is insufficient for movement to a destination, the user may input the low battery capacity information to the user terminal 100. Herein, the low battery capacity information may include the current battery capacity of the drive module 300, the current location of the drive module 300, the destination, the space module information, the drive module information, the occupant information, and the like.

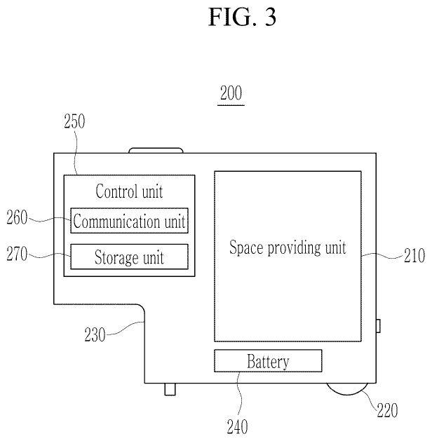

The space module 200 may provide the user with a space that may be used for a specific purpose. The space module 200 is movable when coupled with the drive module 300. As such, the user may use the desired space from any location through the space module 200. For example, the user may use the space module 200 as a living space or a warehouse, and when it is necessary to move the space module 200, the user may call the drive module 300 to couple the drive module 300 to the space module 200 and may move the space module 200 to the desired place. According to the embodiment, the space module 200 may include a space providing part 210, a movement part 220, a coupling part 230, a battery 240, a control unit 250, a communication unit 260, and a storage unit 270. Each of these configurations of the space module 200 is described in more detail below with reference to FIG. 3.

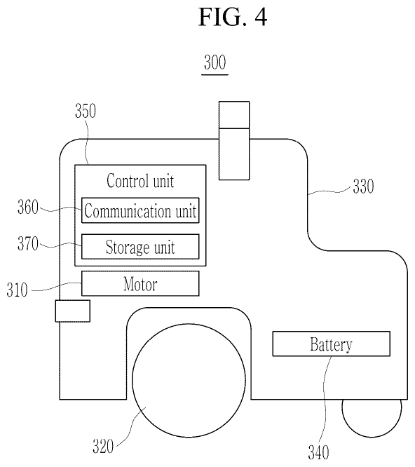

The drive module 300 may generate power to move. The drive module 300 may be coupled to the space module 200 to move the space module 200 to a destination. The drive module 300 may be a transportation means capable of autonomously driving. The drive module 300 may be an economy type, a standard type, or a high performance type. The economy type drive module 300 may be a module with a low power motor and a high capacity battery. The standard type drive module 300 may be a module with a moderate power motor and a moderate capacity battery, and the high performance drive module 300 may be a module with a high power motor and a low capacity battery. According to the embodiment, the drive module 300 may include a motor 310, a movement part 320, a coupling part 330, a battery 340, a control unit 350, a communication unit 360, and a storage unit 370. Each of these configurations of the drive module 300 is described in more detail below with reference to FIG. 4.

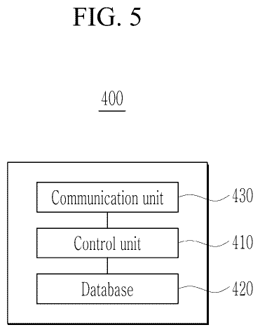

The server 400 may, through communication with the space module 200, the drive module 300, and the user terminal 100, call the drive module 300 to the location where the space module 200 is located. The server 400 may couple the drive module 300 and the space module 200 to move the space module 200 to the desired location. Additionally, the server 400 may release the coupling of the drive module 300 and the space module 200 and may return the drive module 300 to the station. The server 400 may search for a drive module 300 that is capable of moving the space module 200 to a destination among the plurality of drive modules 300, by using the space module information and the drive module information. In accordance with the embodiment, the server 400 may include a control unit 410, a database 420, and a communication unit 430. Each of these configurations of the server 400 is described in more detail below with reference to FIG. 5.

The network 500 refers to a connection structure that allows information exchange between each of the nodes, such as the space module 200, the user terminal 100, the drive module 300, and the server 400. For example, the network 500 may include a local area network (LAN), a wide area network (WAN), the Internet (world wide web (WWW))), a wired or wireless data communication network, a telephone network, a wired or wireless television communication network, and the like. Wireless data communication networks may include 3G, 4G, 5G, 3^{rd} generation partnership project (3GPP), long term evolution (LTE), world interoperability for microwave access (WIMAX), Wi-Fi, Bluetooth communication, infrared communication, ultrasonic communication, visible light communication (VLC), and LiFi, but are not limited thereto.

FIG. 3 is a diagram for illustrating the space module 200 according to an embodiment of the present disclosure.

Referring to FIG. 3, the space module 200 according to the embodiment of the present disclosure may include the space providing part 210, the movement part 220, the coupling part 230, the battery 240, the control unit 250, the communication unit 260, and the storage unit 270.

The space providing part 210 may refer to an empty space formed within the space module 200 in a configuration for providing space to a user. In the embodiment, the space providing part 210 may accommodate a user, appliances, or items. The space providing part 210 may have various shapes based on the intended use of the space module 200 by the user. For example, the space providing part 210 may be used as a living space in which electrical equipment, household appliances, furniture, and the like are installed.

The movement part 220 is a configuration for moving the space module 200, such that the space module 200 may be moved as the power generated by the drive module 300 is transmitted to the movement part 220 of the space module 200 in the state where the space module 200 is coupled with the drive module 300. In this case, the power generated by the drive module 300 may be directly or indirectly transmitted to the movement part 220.

The coupling part 230 is a configuration for coupling with the drive module 300 and may have a structure capable of being engaged with the drive module 300. The engagement structure for coupling the drive module 300 and the space module 200 may be any of a variety of methods known in the art.

The battery 240 may store energy used by the space providing part 210, and energy for movement of the space module 200. The capacity of the battery 240 may be set based on the size and weight of the space module 200. For example, the battery 240 may have a large battery capacity when the space module 200 is large and heavy and may have a small battery capacity when the space module 200 is small and light.

The control unit 250 is a configuration for controlling the space module 200. The control unit 250 may control the space module 200 to be coupled with the drive module 300 according to a coupling signal received from the server 400. The control unit 250 may control the space module 200 to be decoupled from the drive module 300 according to a decoupling signal received from the server 400. The control unit 250 may control communication with the user terminal 100, the server 400, and the drive module 300.

The control unit 250 may calculate the current location of the space module 200 by using a GPS or the like. The control unit 250 may calculate the current location of the space module 200 according to a control signal from the user terminal 100 and may transmit the current location of the space module 200 to the user terminal 100.

The communication unit 260 may communicate with the user terminal 100, the server 400, and the drive module 300 over the network 500. FIG. 3 illustrates that the communication unit 260 is included within the control unit 250. However, in another embodiment, the communication unit 260 may be a separate configuration from the control unit 250.

The storage unit 270 may record space module information. The space module information may include the type, size, and weight of the space module 200, the capacity of the embedded battery, and the like. FIG. 3 illustrates that the storage unit 270 is included within the control unit 250. However, in another embodiment, the storage unit 270 may be a separate configuration from the control unit 250.

FIG. 4 is a diagram for illustrating the drive module 300 according to an embodiment of the present disclosure.

Referring to FIG. 4, the drive module 300 according to the embodiment of the present disclosure may include the motor 310, the movement part 320, the coupling part 330, the battery 340, the control unit 350, the communication unit 360, and the storage unit 370.

The motor 310 may generate power to move the drive module 300 and the space module 200. Power generated by the motor 310 may be transmitted to the movement part 220 of the space module 200 through the body and the coupling part 330 of the drive module 300, the body and the coupling part 230 of the space module 200, and the movement part 220 of the space module 200.

The movement part 320 is a configuration for movement of the drive module 300, and the drive module 300 may be moved as the movement part 320 rotates by receiving power from the motor 310.

The coupling part 330 is a configuration for coupling with the space module 200 and may have a structure capable of being engaged with the space module 200. The engagement structure for coupling the drive module 300 and the space module 200 may be any of a variety of methods known in the art.

The battery 340 may store energy for movement of the drive module 300 and the space module 200. The battery capacity of the drive module 300 may be variously set based on the size, weight, and type of the drive module 300. For example, the drive module 300 for high-speed operation and short-distance operation may have a low-capacity battery, and the drive module 300 for low-speed operation and long-distance operation may have a high-capacity battery.

The control unit 350 is a configuration for controlling the drive module 300. The control unit 350 may control the drive module 300 to move to a call place and a destination according to a call signal received from the server 400. The control unit 350 may control the drive module 300 to move to a station according to a return signal received from the server 400. The control unit 350 may control communication with the user terminal 100, the server 400, and the space module 200.

The control unit 350 may control coupling and decoupling with the space module 200. According to the embodiment, the control unit 350 may determine whether to couple the drive module 30 with the space module 200 based on a result of identity verification. In this case, the identity verification may be performed through an NFT, DID, or the like. For example, the control unit 350 may make a request for identity verification to the user terminal 100 after the drive module 300 has completely moved to the call place. The control unit 350 may initiate coupling with the space module 200 when the identity verification confirms that it is the party that called the drive module 300. The control unit 350 may return to the station without attempting to couple with the space module 200 when the identity verification is not performed for a period of time. According to the embodiment, the control unit 350 may determine whether to decouple the drive module 300 from the space module 200 based on whether a fee has been paid. For example, the control unit 350 may request fee payment from the user terminal 100 after the drive module 300 and the space module 200 have completely moved to a destination. The control unit 350 may decuple the drive module 300 from the space module 200 when the fee payment is completed.

The control unit 350 may determine whether a failure of each of the configurations included in the drive module 300 has occurred. When it is determined that at least one of the configurations included in the drive module 300 has failed, the control unit 350 may recognize information about the circumstances of the failure. For example, when it is determined that a failure has occurred in the communication unit, the control unit 350 may determine that a failure has occurred in the drive module 300 and may simultaneously determine that the drive module 300 is in an operable state. When it is determined that a failure has occurred in the movement part or the motor, the control unit 350 may determine that a failure has occurred in the drive module 300 and may simultaneously determine that the drive module 300 is in an inoperable state. The control unit 350 may transmit failure situation information to the server 400.

The control unit 350 may determine whether the battery of the drive module 300 is low while the drive module 300 is moving in combination with the space module 200. The control unit 350 may determine whether the battery of the drive module 300 is low by comprehensively considering the distance from the current location of the drive module 300 to the destination, the remaining battery capacity of the drive module 300, the remaining battery capacity of the space module 200, and the like. When the control unit 350 determines that the battery capacity of the drive module 300 is low, the control unit 350 may transmit the low battery capacity information to the server 400.

The communication unit 360 may communicate with the user terminal 100, the server 400, and the space module 200 over the network 500. FIG. 4 illustrates that the communication unit 360 is included within the control unit 350. However, in another embodiment, the communication unit 360 may be a separate configuration from the control unit 350.

The storage unit 370 may record drive module information. The drive module information is information about the drive module 300, which may include the location of the station where the drive module 300 is parked, the type, size, weight of the drive module 300, the capacity of the built-in battery, and the like.

FIG. 4 illustrates that the storage unit 370 is included within the control unit 350. In another embodiment, the storage unit 370 may be a separate configuration from the control unit 350.

FIG. 5 is a diagram for illustrating the server 400 according to the embodiment of the present disclosure.

Referring to FIG. 5, the server 400 according to the embodiment of the present disclosure may include a control unit 410, a database 420, and a communication unit 430.

The control unit 410 may receive user information and space module information from the user terminal 100. The control unit 410 may receive drive module information from the drive module 300. The control unit 410 may store the user information, the space module information, and the drive module information in the database 420.

The control unit 410 may receive call information from the user terminal 100. The control unit 410 may search for an available drive module 300 among the plurality of drive modules 300 by using the space module information, the drive module information, and the invocation information. Here, the available drive module 300 means a drive module 300 that is capable of moving the space module 200 to the destination.

In accordance with the embodiment, the control unit 410 may detect a location of a short-distance station closest to the call place among the plurality of stations where the plurality of drive modules 300 is located by reflecting the time of use, call place, and/or expected traffic conditions. The control unit 410 may detect a fully charged drive module 300 within the short-distance station as an available drive module 300. When there is no fully charged drive module 300 within the short-distance station, the control unit 410 may search for a station closer to the call place after the short-distance station among the plurality of stations and may search for a fully charged drive module 300 within that corresponding station.

In accordance with the embodiment, the control unit 410 may search for a drive module 300 that is suitable for moving the space module 200 to the destination by comprehensively considering the type, weight, and battery capacity of the space module 200, the type, weight, and battery capacity of the drive module 300, the number of occupants, the total weight of the occupants, the energy required for the drive module 300 to move to the call place, the energy required for the drive module 300 to move from the call place to the destination in the state where the drive module 300 is coupled with the space module 200, and the like.

For example, the control unit 410 may calculate first energy required for the drive module 300 to move to the call place and may calculate second energy required for the drive module 300 to move from the call place to the destination in the state where the drive module 300 is coupled with the space module 200 based on the weight of the space module 200, the weight of the drive module 300, the total weight of the occupants in the space module 200, the movement distance to the call place, and the movement distance from the call place to the destination. The control unit 410 may compare the first energy and the second energy to the sum of the battery capacity of the space module 200 and the battery capacity of the drive module 300 to search for available drive modules.

The control unit 410 may generate a drive module list by listing information about the available drive modules 300. The control unit 410 may transmit the drive module list to the user terminal 100. In accordance with the embodiment, the drive module list may include a use fee for each drive module 300. The use fee for each drive module 300 may be calculated based on the amount of time the drive module 300 to be used. For example, the use fee for the drive module 300 may be calculated based on the estimated time the drive module 300 is expected to spend to move to the call place, the estimated time the drive module 300 is expected to spend to be coupled with the space module 200 and move from the call place to the destination, or the like.

The control unit 410 may receive drive module selection information from the user terminal 100. The control unit 410 may transmit a call signal including the call information to the selected drive module 300 corresponding to the drive module selection information. In accordance with the embodiment, the control unit 410 may receive movement information from the selected drive module 300 in real time while the selected drive module 300 is coupled with the space module 200 and is moving. Here, the movement information may include location information of the selected drive module 300 and the time of use of the selected drive module 300. The control unit 410 may calculate an estimated arrival time of the selected drive module 300 and the space module 200 and may determine whether additional fees will be incurred by using the real-time movement information. The control unit 410 may transmit the estimated arrival time and the information about whether additional fees will be incurred to the user terminal 100.

The control unit 410 may receive return information from the user terminal 100. The control unit 410 may search for a station that is the shortest distance from the location of the selected drive module 300 among the plurality of stations at which the plurality of drive modules is located by using the return information. The control unit 410 may transmit a return signal including location information of the shortest distance station to the selected drive module 300. In accordance with the embodiment, the control unit 410 may search for at least one first station in the plurality of stations to which the selected drive module 300 is capable of moving with a remaining battery capacity from the location of the selected drive module 300. The control unit 410 may search for a second station that has remaining space for parking the selected drive module 300 in the at least one first station. The control unit 410 may generate and transmit a return signal including location information of the second station to the selected drive module 300.

The control unit 410 may receive failure situation information from the user terminal 100 or the selected drive module 300 indicating a failure of the selected drive module 300. The control unit 410 may search for a station closest to the location where the failure occurred in the selected drive module 300 among the plurality of stations where the plurality of drive modules is located by using the failure situation information. The control unit 410 may determine whether a replaceable drive module exists that may replace the selected drive module 300. Based on the failure situation information, the control unit 410 may determine whether the failed selected drive module 300 is currently in the operable state. The control unit 410 may transmit, to the replaceable drive module, a call signal that controls the replaceable drive module to move to the location where the failure occurred. The control unit 410 may transmit, to the failed drive module 300, a return signal that controls the failed drive module 300 to return to the closest station.

In accordance with the embodiment, the control unit 410 may simultaneously transmit the call signal to the replaceable drive module and the return signal to the failed selected drive module 300. For example, the control unit 410 may transmit the call signal to the replaceable drive module and the return signal to the failed selected drive module 300 simultaneously when the failed selected drive module 300 is in the operable state.

In accordance with the embodiment, the control unit 410 may first transmit the call signal to the replaceable drive module and may transmit the return signal to the failed selected drive module 300 after the replaceable drive module has completely moved to the location where the failure occurred. For example, the control unit 410 may transmit, to a car carrier, a call signal that controls the car carrier to load the replaceable drive module and move to the location where the failure occurred when the failed drive module 300 is in the inoperable state. The control unit 410 may transmit, to the car carrier, a return signal that controls the car carrier to move to the location where the failure occurred, load the failed selected drive module 300, and return to the closest station.

The control unit 410 may receive low battery capacity information from the user terminal 100 or the drive module 300. The control unit 410 may search for a nearby charging station or stations in a route from the current location of the drive module 300 to the destination by using the low battery capacity information. The control unit 410 may transmit, to the searched charging station or station, a signal that controls the drive module 300 to move to the searched charging station or station.

The database 420 may store user information, space module information, drive module information, and station information.

The communication unit 430 may communicate with the user terminal 100, the space module 200, and the drive module 300 over the network 500.

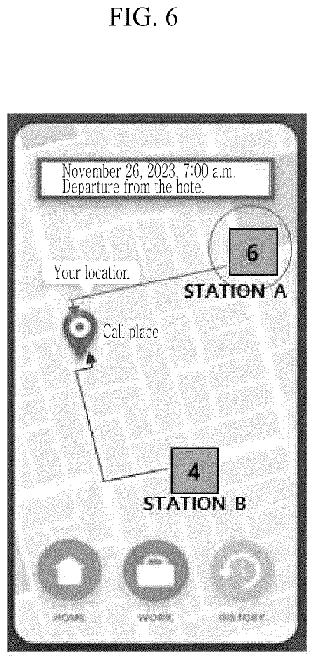

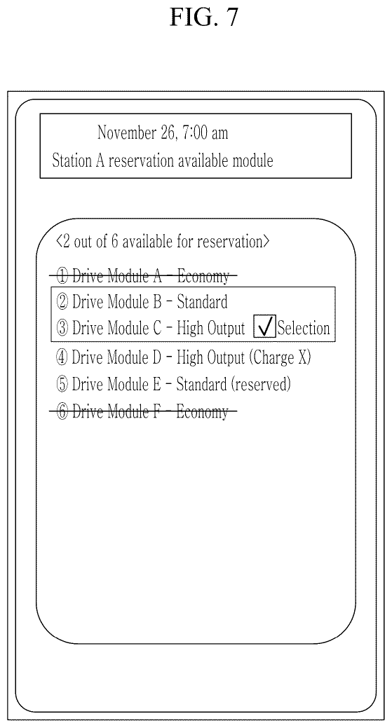

FIGS. 6 and 7 are diagrams illustrating the server 400 according to the embodiment of the present disclosure.

FIG. 6 illustrates the process of the server 400 discovering a short-distance station close to the call place based on the time of use and the call place. Referring to FIG. 6, the server 400 may search for stations A and B within a certain distance relative to the call place. The server 400 may search for the number of fully charged drive modules 300 (A:6, B:4) within the stations A and B. When the distances from the call places to the stations A and B are the same, the server 400 may search for the station A, which is capable of fastest arriving at the call place among the stations A and B in the vicinity of the call place, based on the time of use and/or traffic conditions.

FIG. 7 is an example of a drive module list generated by the server 400. Referring to FIG. 7, the server 400 may generate a drive module list by listing a plurality of drive modules 300 that is capable of moving the space module 200 to a destination. In the embodiment, the drive module list may include information about available drive modules 300 (i.e., drive modules that is capable of moving the space module 200 to the destination) as well as information about unavailable drive modules 300.

For example, as illustrated in FIG. 7, the available drive modules \textcircled{2} and \textcircled{3} may be distinguished from the unavailable drive modules \textcircled{1}, \textcircled{4}, \textcircled{5}, and \textcircled{6} by a square. Furthermore, the drive module \textcircled{4} that cannot be charged until the time of use and the drive module \textcircled{5} that cannot be used because it is scheduled to be used by another user at the same time (i.e., is completely reserved) may be displayed in the list of power modules together with the reason why the drive modules \textcircled{4} and \textcircled{5} cannot be used. Further, the drive modules \textcircled{1} and \textcircled{6} that are unavailable due to the characteristics of the space module 200 and the operating environment may be marked with a strikethrough. For example, when the standard type and the high-performance type drive modules 300 is required due to the characteristics of the space module 200, the economy type drive module corresponds to the unavailable drive module 300, so the economy type drive modules \textcircled{1} and \textcircled{6} may be marked with a strikethrough.

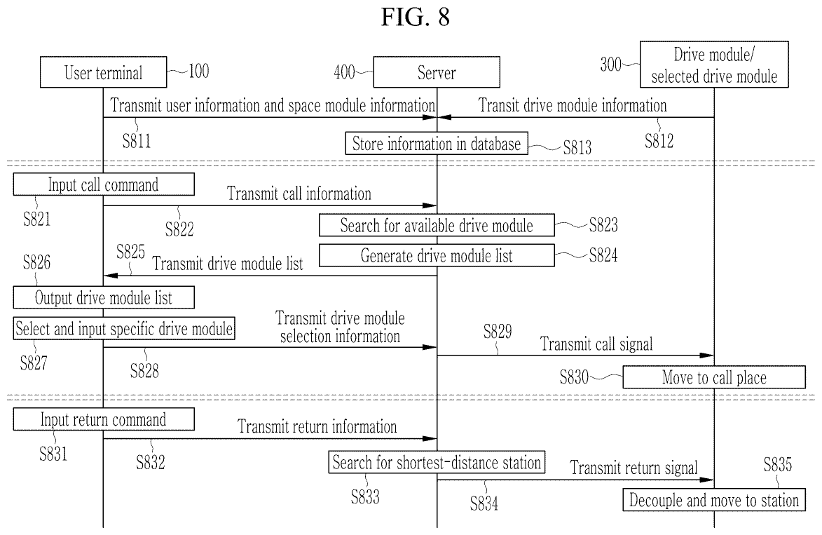

FIG. 8 is a flow diagram illustrating a process of calling the drive module 300 by the user terminal 100.

Referring to FIG. 8, a process of calling the drive module 300 by the user terminal 100 to move the space module 200 to a destination and then returning the drive module 300 to the station is illustrated.

The user may input user information and space module information into the user terminal 100. The user terminal 100 may transmit the user information and the space module information to the server 400 (S811). The drive module 300 may transmit the drive module information to the server 400 (S812). The server 400 may store the user information, the space module information, and the drive module information in a database (S813).

The user may input a call command for calling the drive module 300 through the user terminal 100 (S821). In this case, the call command may include call information, such as a call place, a destination, the space module information, and occupant information. The user terminal 100 may transmit the call information to the server 400 (S822).

The server 400 may search for an available drive module 300 among the plurality of drive modules 300 by using the call information (S823). In this case, the available drive module 300 means a drive module 300 that is capable of moving the space module 200 to the destination. The server 400 may generate a drive module list by listing information about the available drive modules 300 (S824).

The server 400 may transmit the drive module list to the user terminal 100 (S825). The user terminal 100 may print the drive module list and may provide the output drive module list to the user (S826). The user may select any one of the plurality of drive modules 300 included in the drive module list provided through the user terminal 100 and may input the selected drive module 300 into the user terminal 100 (S827).

The user terminal 100 may transmit information about the selected drive module 300 selected by the user (i.e., drive module selection information) to the server 400 (S828). The server 400 may transmit a call signal to the selected drive module 300 corresponding to the drive module selection information (S829). The selected drive module 300 may move to the call place according to the call signal, and after completing the movement to the call place, the selected drive module 300 may move to the destination while being coupled with the space module 200 (S830).

After completing the movement to the destination, the user may input a return command for the selected drive module 300 through the user terminal 100 (S831). Here, the return command may include return information, such as the current location of the selected drive module 300. The user terminal 100 may transmit the return information to the server 400 (S832).

The server 400 may search for a station that is the shortest distance from the location of the selected drive module 300 among a plurality of stations where the plurality of drive modules is located by using the return information (S833). The server 400 may transmit a return signal to the selected drive module 300 for returning the selected drive module 300 to the searched shortest-distance station (S834). According to the return signal, the selected drive module 300 may be decoupled from the space module 200 and move to the station (S835).

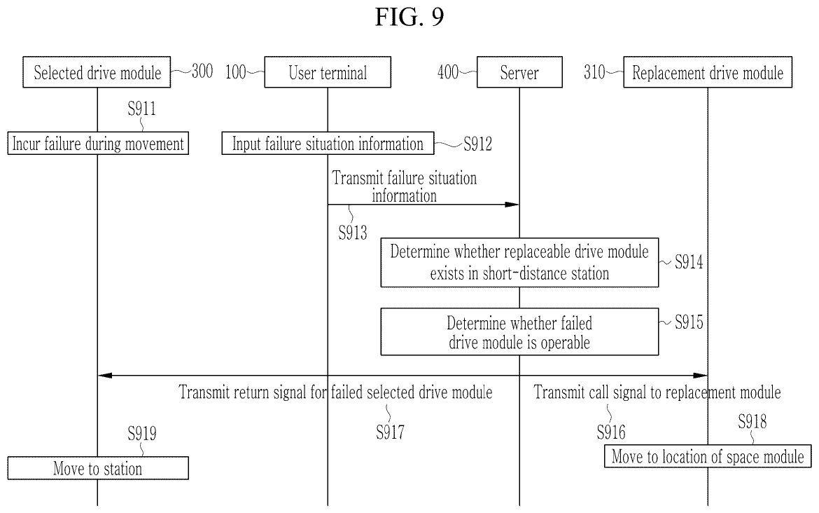

FIG. 9 is a flow diagram for illustrating the process of calling a replaceable module 300 from the user terminal 100 in the event of a failure of the selected drive module 300 while the drive module 300 is coupled to the space module 200.

Referring now to FIG. 9, a process is illustrated in which a user calls a replaceable drive module 310 and moves the selected drive module 300 to a station in the event of a failure of the selected drive module 300 while the selected drive module 300 is coupled to the space module 200.

The selected drive module 300 may have failure while moving in the state of being coupled to the space module 200 (S911).

In this case, the user may input information about the failure situation (hereinafter referred to as “failure situation information”) through the user terminal 100 (S912). Here, the failure situation information may include the type of failure that occurred in the selected drive module 300, whether the drive module 300 is operable, and the location where the failure occurred.

The user terminal 100 may transmit the failure situation information to the server 400 (S913).

The server 400 may search for the station closest to the location where the failure occurred in the plurality of stations where the plurality of drive modules 300 is located by using the failure situation information. The server 400 may determine whether an alternate drive module 310 that may replace the selected drive module 300 exists within the corresponding station (S914).

The server 400 may determine whether the failed selected drive module 300 is operable based on the failure situation information (S915).

The server 400 may transmit, to the replaceable drive module 310, a call signal that controls the replaceable drive module 310 to move to the location where the failure occurred (S916). The server 400 may transmit, to the failed selected drive module 300, a return signal that controls the failed selected drive module 300 to return to the closest station (S917).

The replaceable drive module 310 may move to the location of the failure according to the call signal and be coupled the space module 200 to move the space module 200 to the destination (S918). The failed selected drive module 300 may, according to the return signal, decouple from the space module 200 and may move to the closest station (S919).

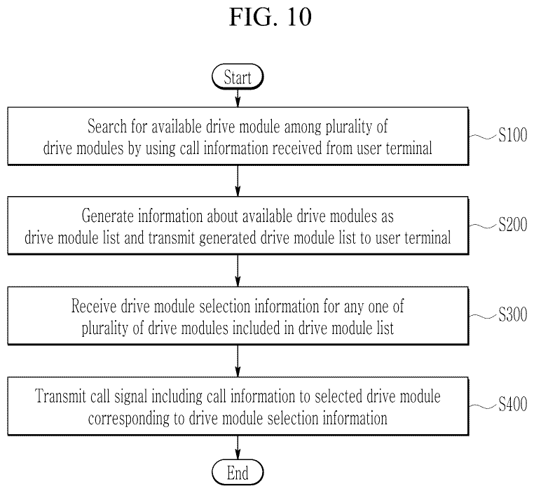

FIG. 10 is a flowchart of a method for controlling a separate mobility module according to an embodiment of the present disclosure.

Referring to FIG. 10, a separate mobility control method according to an embodiment of the present disclosure may include a drive module searching operation S100, a drive module list transmitting operation S200, a drive module selection information receiving operation S300, and a call signal transmitting operation S400.

In the drive module search operation S100, the server 400 may search for an available drive module 300 among the plurality of drive modules 300 by using the call information included in the call command to call the drive module 300 input from the user terminal 100 of the user. Herein, the available drive module 300 refers to a drive module 300 that is capable of moving the space module 200 to a destination.

In accordance with the embodiment, the drive module searching operation S100 may include an operation of searching for a location of a short-distance station that is closest to the call place based on the time of use, call place, and/or expected traffic conditions among a plurality of stations where a plurality of drive modules 300 is located, and an operation S112 of searching for a fully charged drive module 300 within the short-distance station as an available drive module 300.

In accordance with the embodiment, the drive module searching operation S100 may include an operation of searching for a station close to the call place after the short-distance station among the plurality of stations and searching for a drive module 300 that is fully charged within the corresponding station when there is no drive module 300 that is fully charged within the short-distance station.

According to the embodiment, in the drive module searching operation S100, the server 400 may search for a drive module 300 that is suitable for moving the space module 200 to the destination by comprehensively considering the type, weight, and battery capacity of the space module 200, the type, weight, and battery capacity of the drive module 300, the number of occupants, the total weight of the occupants, the energy required for the drive module 300 to move to the call place, the energy required for the drive module 300 to move from the call place to the destination in the state where the drive module 300 is coupled with the space module 200, and the like.

For example, the server 400 may calculate first energy required for the drive module 300 to move to the call place and may calculate second energy required for the drive module 300 to move from the call place to the destination in the state where the drive module 300 is coupled with the space module 200 based on the weight of the space module 200, the weight of the drive module 300, the total weight of the occupants in the space module 200, the movement distance to the call place, and the movement distance from the call place to the destination. The server 400 may compare the first energy and the second energy to the sum of the battery capacity of the space module 200 and the battery capacity of the drive module 300 to search for available drive modules.

In the drive module list transmitting operation S200, the server 400 may generate information about the available drive modules 300 as a drive module list and may transmit the generated drive module list to the user terminal 100. For example, the server 400 may generate a drive module list by listing information about drive modules 300 that is capable of moving the space module 200 to the destination.

In accordance with the embodiment, the information about the available drive modules 300 may include a use fee for the available drive modules 300. The use fee for the available drive module 300 may be calculated based on the amount of time the drive module 300 to be used. For example, the use fee for the drive module 300 may be calculated based on the estimated time the drive module 300 is expected to spend to move to the call place, the estimated time the drive module 300 is expected to spend to be coupled with the space module 200 and move from the call place to the destination, or the like.

In the drive module selection information receiving operation S300, the server 400 may receive drive module selection information for any one of the plurality of drive modules 300 included in the drive module list from the user terminal 100.

In the call signal transmitting operation S400, the server 400 may transmit a call signal including the call information to the selected drive module 300 corresponding to the drive module selection information.

According to the embodiment, the call signal transmitting operation S400 may include an operation of receiving real-time movement information from the selected drive module 300 while the selected drive module 300 is coupled with the space module 200 and moves. The call signal transmitting operation

S400 may include an operation of calculating an estimated arrival time of the selected drive module 300 and the space module 200 and whether an additional fee is incurred by using the movement information. The call signal transmitting operation S400 may include an operation of transmitting the estimated arrival time and whether the additional fee is incurred to the user terminal 100. Here, the movement information may include location information of the selected drive module 300 and the time of use of the selected drive module 300.

The separate mobility control method according to the embodiment may further include a shortest distance station searching operation and a return signal transmitting operation.

In the shortest distance station searching operation S510, the server 400 may search for a station that is the shortest distance from the location of the selected drive module 300 among the plurality of stations where the plurality of drive modules 300 is located by using the return information included in the return command of the selected drive module 300 input from the user terminal 100.

In accordance with the embodiment, the shortest distance station searching operation S510 may include searching for, among the plurality of stations, at least one first station to which the selected drive module 300 is capable of moving from the current location of the selected drive module 300 with a battery capacity remaining in the selected drive module 300, and searching for, among the at least one first station, a second station having remaining space to park the selected drive module 300

In the return signal transmitting operation S520, the server 400 may transmit a return signal including location information of the shortest distance station to the selected drive module 300.

The separate mobility control method according to the embodiment may include a station searching operation, a replaceable module searching operation, and a call signal transmitting operation.

In the station searching operation, the server 400 may receive failure situation information indicating a failure of the selected drive module 300 from the user terminal 100 or the selected drive module 300. The server 400 may search for the station closest to the location where the failure occurred among a plurality of stations where the plurality of drive modules is located by using the failure situation information.

In the replaceable module searching operation, the server 400 may determine whether an alternate drive module capable of replacing the selected drive module 300 exists within the closest station that may replace the selected drive module 300.

In the call signal transmitting operation S630, the server 400 may transmit, to the replaceable drive module, a call signal that controls the replaceable drive module to move to the location where the failure occurred.

According to the embodiment, the call signal transmitting operation S630 may include determining, based on the failure situation information, whether the failed selected drive module 300 is currently in an operable state. The call signal transmitting operation may include, when the failed selected drive module 300 is in the operable state, transmitting a call signal to a replaceable drive module and simultaneously transmitting a return signal to the failed selected drive module 300. The call signal transmitting operation may include, when the failed selected drive module 300 is in an inoperable state, transmitting, to a car carrier, a call signal that controls the car carrier to load the replaceable drive module and move to the location where the failure occurred and transmitting, to the car carrier, a return signal that controls the car carrier to move to the location where the failure occurred, load the failed selected drive module 300, and return to the closest station

The method described above may be implemented in a general-purpose digital computer that may be written as a program executable on a computer. The general-purpose digital computer operates the program using a computer-readable recording medium. The computer-readable recording medium may include a storage medium, such as a magnetic storage medium such as a ROM, RAM, USB, floppy disk, hard disk, or an optical reading medium, such as a CD-ROM or DVD.

The scope of the present disclosure is indicated by the following claims rather than by the detailed description above, and the meaning and scope of the claims and all modifications or variations derived from the equivalents thereof shall be construed to be included in the scope of the present disclosure.

What is claimed is:

1. A system for controlling a separate mobility module, the system comprising:
the separate mobility module comprising
a space module, and
a plurality of drive modules configured to generate power to move and configured to be coupled with the space module to move the space module to a destination; and
a server configured to
search for an available drive module among the plurality of drive modules by using call information included in a call command for calling the drive module received from a user terminal of a user,
generate information about the available drive module into a drive module list,
transmit the drive module list to the user terminal,
receive drive module selection information about any one of the plurality of drive modules included in the drive module list from the user terminal, and
transmit a call signal including the call information to a selected drive module corresponding to the drive module selection information.

2. The system of claim 1, wherein:
the space module is configured to provide a user with a space usable with a specific purpose.

3. The system of claim 1, wherein:
the call information includes a call place, and
the call place includes location information calculated through a GPS installed on the user terminal or a GPS installed on the space module.

4. The system of claim 1, wherein the server is further configured to:
search for a short-distance station closest to a call place among a plurality of stations where a plurality of power modules is located based on a time of use and the call place included in the call information; and
search for a drive module completely charged within the short-distance station as the available drive module.

5. The system of claim 4, wherein the server is further configured, when there is no fully charged drive module within the short-distance station, to:
search for a station closer to the call place after the short-distance station among the plurality of stations; and
search for a fully charged drive module within the corresponding station.

6. The system of claim 1, wherein the server is further configured to:
calculate first energy required for the available drive module to move to a call place and second energy required for the available drive module to move from the call place to a destination in a state where the available drive module is coupled with the space module based on a weight of the space module, a weight of the available drive module, a total weight of occupants in the space module, a movement distance to the call place, and a movement distance from the call place to the destination; and
compare the first energy and the second energy to a sum of a battery capacity of the space module and a battery capacity of the available drive module to search for the available drive module.

7. The system of claim 1, wherein:
the drive module list includes a use fee for the available drive module calculated based on an amount of time the plurality of drive modules to be used.

8. The system of claim 1, wherein the server is further configured to:
receive real-time movement information from the selected drive module while the selected drive module is coupled with the space module and moves;
calculate an estimated arrival time of the selected drive module and the space module;
determine whether an additional fee is incurred by using the real-time movement information; and
transmit the estimated arrival time and information about whether the additional fee is incurred to the user terminal.

9. The system of claim 1, wherein the server is further configured to:
search for a station having a shortest distance from a location of the selected drive module among a plurality of stations where the plurality of drive modules is located by using return information included in a return command of the selected drive module received from the user terminal; and
transmit a return signal including location information of the station having the shortest distance to the selected drive module.

10. The system of claim 9, wherein the server is further configured to:
search for at least one first station in the plurality of stations to which the selected drive module is capable of moving with a remaining battery capacity from the location of the selected drive module; and
search for a second station that has remaining space for parking the selected drive module in the at least one first station.

11. The system of claim 1, wherein the server is further configured to:
receive failure situation information from the user terminal or the selected drive module indicating a failure of the selected drive module;
search for a station closest to a location where the failure occurred among a plurality of stations where the plurality of drive modules is located by using the failure situation information;
determine whether a replaceable drive module exists that is capable of replacing the selected drive module within the closest station; and
transmit, to the replaceable drive module, a call signal that controls the replaceable drive module to move to the location where the failure occurred.

12. The system of claim 11, wherein the server is further configured to:
determine, based on the failure situation information, whether the selected drive module having the failure is currently in an operable state;
when the selected drive module having the failure is in the operable state, transmit a call signal to the replaceable drive module and transmit a return signal to the selected drive module having the failure; and
when the selected drive module having the failure is in an inoperable state, transmit, to a car carrier, a call signal that controls the car carrier to load the replaceable drive module and to move to the location where the failure occurred, and transmit, to the car carrier, a return signal that controls the car carrier to move to the location where the failure occurred, to load the selected drive module having the failure, and to return to the closest station.

13. A method of controlling a separate mobility module, the method comprising:
searching, by a server, for an available drive module among a plurality of drive modules by using call information included in a call command for calling a drive module received from a user terminal of a user;
generating, by the server, information about the available drive module into a drive module list;
transmitting, by the server, the drive module list to the user terminal;
receiving, by the server, drive module selection information about any one of the plurality of drive modules included in the drive module list from the user terminal; and
transmitting, by the server, a call signal including the call information to a selected drive module corresponding to the drive module selection information.

14. The method of claim 13, wherein searching for the available drive module includes:
searching, by the server, for a short-distance station closest to a call place among a plurality of stations where a plurality of power modules is located based on a time of use and the call place included in the call information; and
searching, by the server, for a drive module completely charged within the short-distance station as the available drive module.

15. The method of claim 14, wherein searching for the available drive module includes:
when there is no fully charged drive module within the short-distance station, searching, by the server, for a station closer to the call place after the short-distance station among the plurality of stations, and searching, by the server, for a fully charged drive module within the corresponding station.

16. The method of claim 13, wherein:
the drive module list includes a use fee for the available drive module calculated based on an amount of time the plurality of drive modules to be used.

17. The method of claim 13, wherein transmitting the call signal includes:
receiving, by the server, real-time movement information from the selected drive module while the selected drive module is coupled with a space module and moves;
calculating, by the server, an estimated arrival time of the selected drive module and the space module;
determining, by the server, whether an additional fee is incurred by using the real-time movement information; and
transmitting, by the server, the estimated arrival time and information about whether the additional fee is incurred to the user terminal.

18. The method of claim 13, further comprising:
searching, by the server, for a station having a shortest distance from a location of the selected drive module among a plurality of stations where the plurality of drive modules is located by using return information included in a return command of the selected drive module received from the user terminal; and
transmitting, by the server, a return signal including location information of the station having the shortest distance to the selected drive module.

19. The method of claim 18, wherein searching for the station having the shortest distance includes:
searching, by the server, for at least one first station in the plurality of stations to which the selected drive module is capable of moving with a remaining battery capacity from the location of the selected drive module; and
searching, by the server, for a second station that has remaining space for parking the selected drive module in the at least one first station.

20. The method of claim 13, further comprising:
receiving, by the server, failure situation information from the user terminal or the selected drive module indicating a failure of the selected drive module;
searching, by the server, for a station closest to a location where the failure occurred among a plurality of stations where the plurality of drive modules is located by using the failure situation information;
determining, by the server, whether a replaceable drive module exists that is capable of replacing the selected drive module within the closest station; and
transmitting, by the server to the replaceable drive module, a call signal that controls the replaceable drive module to move to the location where the failure occurred.

21. The method of claim 20, wherein transmitting the call signal includes:
determining, by the server based on the failure situation information, whether the selected drive module having the failure is currently in an operable state;
when the selected drive module having the failure is in the operable state, transmitting, by the server, a call signal to the replaceable drive module and transmitting, by the server, a return signal to the selected drive module having the failure; and
when the selected drive module having the failure is in an inoperable state, transmitting, by the server to a car carrier, a call signal that controls the car carrier to load the replaceable drive module and to move to the location where the failure occurred, and transmitting, by the server to the car carrier, a return signal that controls the car carrier to move to the location where the failure occurred, to load the selected drive module having the failure, and to return to the closest station.
